(19) United States
(12) Patent Application Publication
(10) Pub. No.: US 2018/0242076 A1
(43) Pub. Date: Aug. 23, 2018

(54) AERODYNAMICALLY VENTED SUBWOOFER

(71) Applicant: FORD GLOBAL TECHNOLOGIES, LLC, Dearborn, MI (US)

(72) Inventors: Eric R. YERKE, Redford, MI (US); Hillary GREGORY, Livonia, MI (US); Michael McELROY, South Lyon, MI (US); James C. PEITZ, Saline, MI (US)

(21) Appl. No.: 15/438,183

(22) Filed: Feb. 21, 2017

(51) Int. Cl. H04R 1/28

(52) U.S. Cl. CPC H04R 1/2826; H04R 2499/13; H04R 1/288

(57) ABSTRACT

A vehicle subwoofer assembly may include an extractor duct including a first portion and a second portion configured to extract air from the vehicle via a vent, and a subwoofer assembly connected to the duct, wherein the duct is configured to extract air from the vehicle and vent air from the subwoofer.

### TECHNICAL FIELD

This disclosure relates to aerodynamically vented subwoofers.

### BACKGROUND

Vehicles typically include an audio system having speakers, subwoofers, etc. Traditional subwoofers require a large enclosure to allow for sufficient air flow volume necessary to compensate for the air displacement driven by the speakers. Such enclosures produce quality bass tones. However, as vehicles decrease in size, the desired size of subwoofers cannot always be accommodated.

### SUMMARY

A vehicle subwoofer assembly may include an extractor duct including a first portion and a second portion configured to extract air from the vehicle via a vent opening, and a subwoofer assembly connected to the duct, wherein the vent is configured to extract air from the vehicle and vent air from the subwoofer.

A vehicle vent assembly may include an extractor arranged within a vehicle and configured to extract air from the vehicle via a vent at an exterior of the vehicle, and a subwoofer assembly connected to the extractor via a subwoofer vent, wherein the extractor is configured to vent air from within the vehicle and from the subwoofer.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompanying drawings in which:

FIG. 1 illustrates an example subwoofer venting system within a vehicle;

FIG. 2 illustrates a portion of the subwoofer venting system of FIG. 1; and

FIG. 3 illustrates a cross-sectional view of a subwoofer vent of the subwoofer venting system of FIGS. 1 and 2.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

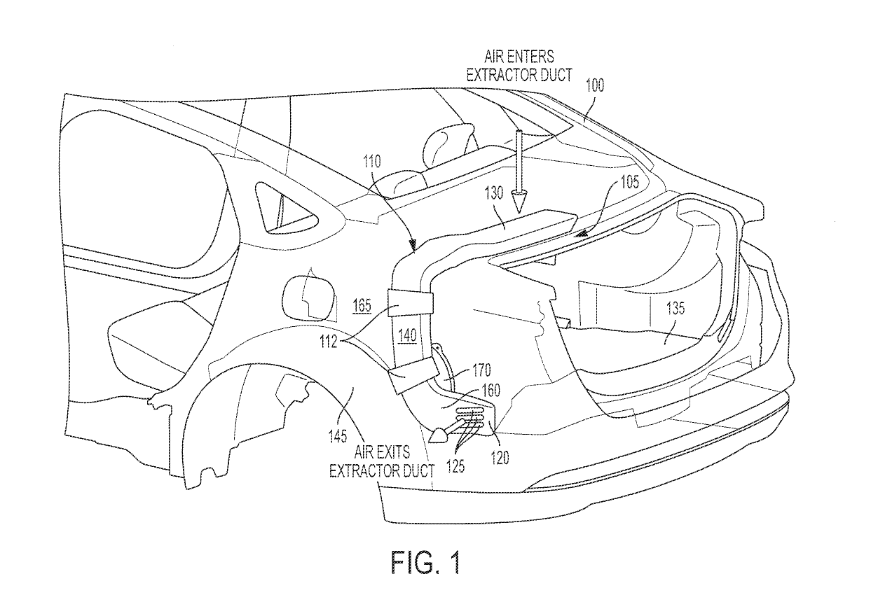

FIG. 1 illustrates an example subwoofer venting system 105 within a vehicle 100. The subwoofer venting system 105 may include an extractor duct 110. The extractor duct 110 may be a duct arranged within the vehicle 100 to move air from one portion of the vehicle 100 to another. The extractor duct 110 may move air from inside the vehicle 100 to outside the vehicle 100. This air may include exhaust and other undesirable air such as warm or cold air that typically cause the glass/windows of a vehicle to fog.

The air may leave the extractor duct 110 via an opening 120 defined on a panel 165 of the vehicle 100. The opening 120 may include at least one flap 125 configured to open in response to increased air pressure from inside the extractor duct. In the example shown in FIG. 1, the flap 125 may include three flaps. More of less flaps may be included.

The flaps 125 may be arranged in a closed position until air pressure within the extractor duct 110 forces the flaps 125 to open. By maintaining the flaps 125 in a closed position, air, moisture, debris, etc., are prevented from entering the vehicle 100 via the extractor duct 110. The flaps 125 may be hinged to the panel 165 of the vehicle allowing gravity to force the flaps into the closed position. The flaps 125 may also include a magnetic element (not shown) configured to magnetically attach to the vehicle to aid in maintaining the flaps 125 in a closed position. Upon air movement within the extractor duct 110, the flaps 125 may be forced open by the air pressure within the extractor duct 110 so that the air therein may exit the vehicle 100.

In the example shown in the figures, the extractor duct 110 may be arranged near the rear of the vehicle 100, though the extractor duct 110 may be arranged in other areas of the vehicle such as the front, bottom, sides, etc. The extractor duct 110 may have a first portion 130 extending at least partially above a vehicle trunk 135. The extractor duct may include a second portion 140 extending downward along a rear side of the vehicle near a wheel base 145.

The second portion 140 may form a right angle or near right angle at a bend 150 with the first portion 130. The second portion 140 may include a distal end 160 configured to open to the opening 120 to vent the air out of the openings 120. The distal end 160 may be attached to the vehicle panel 165. The distal end 160 may create a sealed attachment with the inside of the vehicle panel 165 such that the air is forced out of the vehicle 100. Air may move from the first portion 130 through to the second portion 140 and out of the distal end 160 via the opening 120.

The subwoofer venting system 105 may include a subwoofer 170. The subwoofer 170 may be woofer or a portion of a loudspeaker that is configured to reproduce audio frequencies in the 20-200 HZ range. Typically, subwoofer reproduce bass sound and augment the lower frequency range of loudspeakers. Subwoofers are commonly surrounded by a speaker enclosure that is capable of withstanding air pressure while resisting deformation. Typically, these enclosures are large in order to accommodate air flow volume created by the air displacement as a cone as the subwoofer pulses.

Large enclosures may not always be practical to include in vehicles due to the limited space within certain vehicles. Use of a smaller enclosure may cause the quality of the bass sound to suffer. Further, the lack of space within the vehicle to accommodate an enclosure may result in a subwoofer being excluded from the vehicle design.

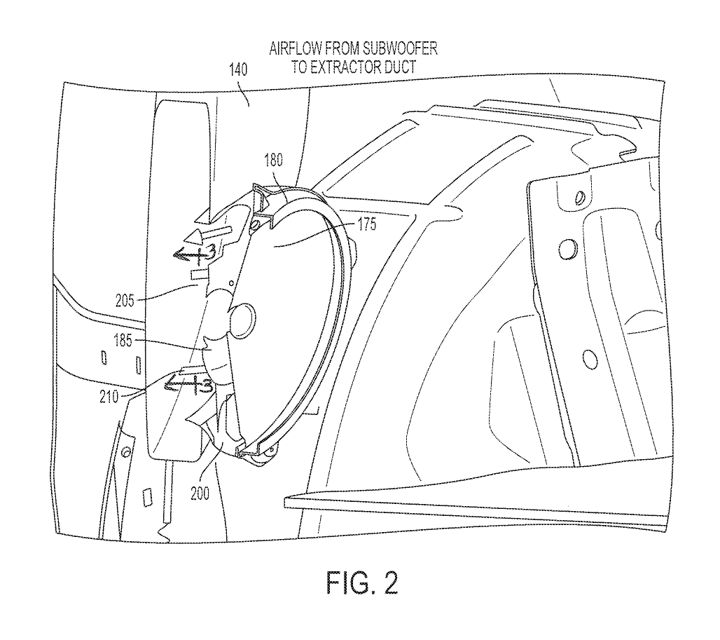

As best seen in FIG. 2, the subwoofer 170 may include a cone 175 and a surround 180 surrounded by a frame 200. A back plate 185 or housing may be arranged on a back of the subwoofer 170 behind a voice coil (not shown). During use, the cone 175 may be displaced and cause air pressure to change within a subwoofer. The amount of cone displacement may be determined based on the cone radius, as well as other factors such as the depth of the subwoofer, magnet size, etc. If the air pressure is too high or too low behind the cone 175, then the sound quality emitted from the subwoofer may be affected.

The second portion 140 of the extractor duct 110 may define a duct opening 205 configured to receive a portion of the subwoofer 170. The duct opening 205 may receive the back plate 185 and at least a portion of the frame 200. Air displaced from the cone 175 during speaker use may then be pushed into the extractor duct 110. Thus, the extractor duct 110 may perform both functions of moving air from inside the vehicle to outside the vehicle (e.g., vehicle air extraction), as well as venting the subwoofer.

The extractor duct 110 may include expansion chambers 112 to prohibit noise, vibration and harshness (NVH) transmissions. Although two expansion chambers 112 are illustrated, more or less may be included.

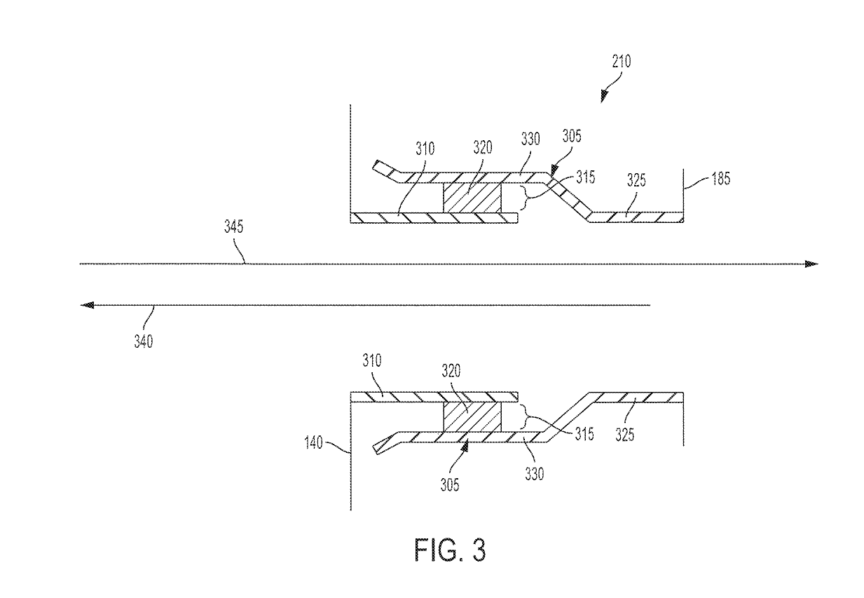

In another example, a subwoofer duct 210 (as best shown in FIG. 2 and explained further with respect to FIG. 3) may be arranged at the back plate 185 and may integrate with the second portion 140 of the extractor duct 110. The subwoofer duct 210 may also maintain a pressure drop around the subwoofer at the optimal level to produce the desired bass tones. That is, the subwoofer duct 210 is configured to extract air from the vehicle as well as relieve back pressure for the subwoofer.

FIG. 3 illustrates a cross-sectional view of the subwoofer vent 210 of the subwoofer venting system 102 of FIGS. 1 and 2. The subwoofer vent 210 may extend from the back plate 185 of the subwoofer 170 to the second portion 140 of the extractor duct 110. The subwoofer vent 210 may connect the subwoofer vent 210 to the extractor duct 110. The subwoofer vent 210 may provide for an air-tight connection between the subwoofer 170 and the extractor duct 110. The subwoofer vent 210 may include a first duct 305 extending from the back plate 185. The subwoofer vent 210 may also include a second duct 310 extending from extractor duct 110. The first duct 305 may have a first portion 325 and a second portion 330 extending therefrom towards the extractor duct 110. The first portion 325 may have a first diameter being smaller than a second diameter of the second portion 330. The second portion 330 of the first duct 305 may taper outwards from the first portion 325 to accommodate and receive the second duct 310. The second portion 330 of the first duct 305 and the second duct 310 may form a gap 315 there between.

A seal 320 may be arranged between the first duct 305 and the second duct 310 to dampen any vibration between the first duct 305 and the second duct 310 created by airflow or other vehicular movement. The seal 320 may be a foam seal forming a cylinder configured surround the second duct 310. The seal 320 may also include one or more foam blocks arranged around the second duct 310. The seal 320 may be arranged between the first duct 305 and the second duct 310 so as to not obstruct airflow within the subwoofer vent 210. The seal 320 may aid in creating an air-tight seal between the subwoofer 170 and the extractor duct 110. Further, the seal 320 may aid in reducing NVH.

Air may flow from the subwoofer 170, through the subwoofer vent 210 and into the extractor duct 110, as illustrated by a first air flow 340 in FIG. 3. Air may flow from the extractor duct 110 to the subwoofer 170 via the subwoofer vent 210 via a second air flow 345.

The subwoofer vent 210 may form an air-tight connection between the subwoofer 170 and the extractor duct 110. The air-tight connection prevents air leakage between the subwoofer 170 and the extractor duct 110. Furthermore, the subwoofer vent 210 may be robust enough to withstand strain created by exposed use of the vehicle.

While the subwoofer vent 210 is illustrated and described herein as being a slip-fit joint, other attachment mechanisms may also be used to attach the subwoofer 170 to the extractor duct 110. For example, snap fits having a tongue and groove may be used in the event of injection molded parts. Parts may be welded together in the event that metallic parts are used.

Accordingly, described herein is an extractor duct configured to receive a portion of a subwoofer so that air may be integrated within the extractor duct to allow a smaller subwoofer enclosure that frees up package volume for other components in the vehicle. That is, the extract duct takes the place of a large enclosure around the subwoofer saving space and components within the vehicle. The duct functions both as an enclosure to vent the subwoofer and as an extractor top save components, money and space.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A vehicle subwoofer assembly, comprising:
an extractor duct configured to extract air from the vehicle via a vent opening at an exterior of the vehicle; and
a subwoofer assembly including a subwoofer vent having a first duct extending from a backside of the subwoofer assembly, the first duct configured to connect the subwoofer vent to the extractor duct by receiving a second vent of the extractor duct, the second vent having a diameter less than that of the first duct, wherein the duct is configured to extract air from the vehicle and relieve back pressure for the subwoofer.

2. (canceled)

3. (canceled)

4. The vehicle subwoofer assembly of claim 1, wherein the subwoofer vent includes a seal arranged between the first duct and a second duct to reduce noise, vibration and harshness (NVH) transmissions.

5. The vehicle subwoofer assembly of claim 1, wherein the vent opening is arranged on an exterior of the vehicle.

6. The vehicle subwoofer assembly of claim 5, further comprising at least one flap arranged over the vent opening and configured to open to release air from the extractor duct and the subwoofer.

7. A vehicle vent assembly, comprising:
an extractor arranged within a vehicle and configured to extract air from the vehicle via a vent at an exterior of the vehicle; and
a subwoofer assembly connected to the extractor via a subwoofer vent, wherein the subwoofer vent includes a first duct and a second duct, the first duct configured to receive the second duct, a diameter of the first duct is greater than a diameter of the second duct and the extractor being configured to vent air from within the vehicle and from the subwoofer.

8. (canceled)

9. The vehicle vent assembly of claim 7, wherein the subwoofer vent includes a seal arranged between the first duct and a second duct to reduce noise, vibration and harshness (NVH) transmissions.

10. The vehicle vent assembly of claim 9, wherein the seal includes a foam ring surrounding a portion of the second duct.

11. (canceled)

12. The vehicle vent assembly of claim 7, wherein the vent is arranged on an exterior of the vehicle.

13. The vehicle vent assembly of claim 12, further comprising at least one flap arranged over the vent and configured to open to release air from the extractor and the subwoofer.

14. The vehicle vent assembly of claim 7, wherein the extractor includes at least one expansion chamber.

15. A vehicle vent assembly, comprising:
a subwoofer having a subwoofer vent arranged at a backside of the subwoofer, wherein the subwoofer vent includes a first duct extending from a backside of the subwoofer; and
an extractor duct having a second vent with a diameter less than that of the first vent where the first vent receiving the second vent to extract air from the backside of the subwoofer to an exterior of the vehicle.
